(19) United States
(12) Patent Application Publication
(10) Pub. No.: US 2012/0237637 A1
(43) Pub. Date: Sep. 20, 2012

(54) ENERGY CHIP FORMULATIONS AND METHOD FOR PREPARATION OF SAME

(75) Inventor: Mario OLMOS, Fort Worth, TX (US)

(73) Assignee: CENTRAL GARDEN & PET COMPANY, Walnut Creek, CA (US)

(21) Appl. No.: 13/420,026

(22) Filed: Mar. 14, 2012

Related U.S. Application Data
(60) Provisional application No. 61/452,544, filed on Mar. 14, 2011.

(51) Int. Cl. A23K 1/18

(52) U.S. Cl. 426/72; 426/661; 426/541; 426/512

(57) ABSTRACT

Energy chip formulations may deliver health and/or energy benefits to birds that consume such energy chips. These energy chip embodiments may include vegetable-based fat, as opposed to animal fat, and these formulations may be healthier for birds while still providing birds with much needed energy. Embodiments also may include one or more vitamins and minerals in the energy chip formulation. Different energy chip formulations may be provided for bird consumption to address birds' dietary and/or energy needs at different times or seasons during a given year. There also may be different embodiments of energy chips that may be provided for use within the same time or season of the year (i.e., several formulations for use in spring months).

### FIELD

The present disclosure relates generally to energy chip formulations for feeding birds, which may be either domesticated or wild animals (i.e. not human), and more specifically, to energy chip formulations that do not contain animal fat and a method for preparation of same.

### BACKGROUND

Birds typically consume lots of fat because fat translates to energy for birds, and migrating (flying) birds need energy. Also, non-migratory birds may require calorie and/or protein-rich food that may be scarce or otherwise unavailable, for example, in winter months. Suet is a high-energy commercially available formulation comprised mainly of animal fat that provides a quick source of heat and energy for birds. In the past, bird enthusiasts might present suet in their backyards in a wire cage or suet log, or hang a piece of suet on a hook to feed birds. While birds enjoy consuming suet, suet is not necessarily a healthy foodstuff for birds and can be difficult for birds to digest. Moreover, suet can be messy if it melts in a bird feeder or in the backyard.

### SUMMARY

Embodiments of the present disclosure generally provide food in the form of energy chip formulations for birds that may be comprised of vegetable fat along with other vitamins and nutrients, and a method for preparation of same. Energy chip formulations according to embodiments of the present disclosure may address birds' different health and/or energy needs during various seasons of the year.

The foregoing has outlined rather broadly the features and technical advantages of the present disclosure in order that the detailed description that follows may be better understood. Additional features and advantages will be described hereinafter which may form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description.

### DETAILED DESCRIPTION

Energy chip formulations according to embodiments of the present disclosure may deliver health and/or energy benefits to birds that consume such energy chips. These energy chip embodiments may include vegetable-based fat, as opposed to animal fat, and these formulations may be healthier for birds while still providing birds with much needed energy. These formulations may be easier to digest than animal fat-based formulations, and they may reduce the likelihood that birds consuming these energy chips will develop fungus on their wings or feathers.

Embodiments of energy chip formulations also may include one or more vitamins and minerals. As an example, incorporating Vitamin E into energy chip formulations may provide birds with valuable antioxidants. Inclusion of carotenoids, such as lutein, in energy chip formulations may aid birds in synthesizing color, allowing them to perhaps become more colorful in appearance. Inclusion of these different components within the pellets or chips containing vegetable fat or variations thereof may help to ensure that the birds will actually consume vitamins and/or minerals that they need, as compared to providing such vitamins/minerals separately from the fat.

Different energy chip formulations may be provided to address birds' dietary and/or energy needs at different times or seasons during a given year. There also may be different embodiments of energy chips that may be provided for use within the same time or season of the year (i.e., several formulations for use in spring months). These variations in energy chip formulations may address specific needs of certain types of birds, or they may be more appropriate for use in different areas of the country or the world according to embodiments of the present disclosure. For example, energy chips of a spring formulation may include calcium to promote egg shell strength. Also, for example, formulations herein may be tailored to a particular time of the year to provide a bird with increased calories and/or protein (e.g. to help build weight and/or muscle prior to migration).

Turning to embodiments of energy chips that may be consumed by birds during spring months, while several different compositions of energy chips may be provided, each formulation generally may include at least the following components: maltodextrin, cornstarch, peanut flour, vegetable shortening, palm oil (e.g. Stable Flake® P, from Cargill, which is a palm oil in flake form, and more particularly a partially hydrogenated palm oil wax with citric acid typically added as a preservative, having an iodine value of 5.0 max, a Mettler dropping Pint of 140° F., a free fatty acid of 0.1% as oleic), lecithin liquid, calcium (e.g. Unical™ S calcium carbonate, from ILC Resources, which is a finely textured uniform granule), powdered salt, and antioxidant (e.g. Naturox™ Plus, from Kemin Industries, which is a dry antioxidant used in the preservation of oils, fats fat soluble vitamins, flavors, aromas, carotenoids and other oxygen-sensitive materials, and that maintains optimal nutritional value and palatability of the fat, oil and meat meal). However, it should be appreciated that other components may be included in spring formulations of energy chips without departing from the present disclosure.

Maltodextrin and cornstarch together generally may comprise approximately 50% by weight of the resultant composition, with maltodextrin and cornstarch generally each comprising approximately 20-35% by weight of the composition. Further, if a higher percentage of maltodextrin may be included in a formulation, generally a lower percentage of cornstarch may be included, and vice versa.

The percentage of peanut flour that may be incorporated into embodiments of the spring energy chip formulation generally may range from approximately 3-5% by weight, with vegetable shortening ranging from approximately 15-25% by weight, palm oil (Stable Flake® P) ranging from approximately 10-15% by weight, lecithin ranging from approximately 1-3% by weight, calcium (Unical™ S) ranging from approximately 1-3% by weight, and powdered salt and antioxidant (Naturox™ Plus) each ranging from approximately 0 to 1% by weight of the resultant composition. A summary of several embodiments of spring energy chip formulations is provided below.

### Spring Formula 1

| | Formula % wt. |
|---|---|
| Maltodextrin | 24.92 |
| Cornstarch | 30.50 |
| Vegetable Shortening | 24.00 |
| Palm Oil (Stable Flake ® P) | 12.00 |
| Peanut Flour | 4.00 |
| Lecithin Liquid | 2.00 |
| Calcium (Unical ™ S) | 2.00 |
| Powdered Salt | 0.50 |
| Antioxidant (Naturox ™ Plus) | 0.08 |

### Spring Formula 2

| | Formula % wt. |
|---|---|
| Maltodextrin | 29.01 |
| Cornstarch | 28.84 |
| Vegetable Shortening | 22.69 |
| Palm Oil (Stable Flake ® P) | 11.35 |
| Peanut Flour | 3.78 |
| Lecithin Liquid | 1.89 |
| Calcium (Unical ™ S) | 1.89 |
| Powdered Salt | 0.47 |
| Antioxidant (Naturox ™ Plus) | 0.08 |

### Spring Formula 3

| | Formula % wt. |
|---|---|
| Maltodextrin | 32.09 |
| Cornstarch | 27.59 |
| Vegetable Shortening | 21.71 |
| Palm Oil (Stable Flake ® P) | 10.85 |
| Peanut Flour | 3.62 |
| Lecithin Liquid | 1.81 |
| Calcium (Unical ™ S) | 1.81 |
| Powdered Salt | 0.45 |
| Antioxidant (Naturox ™ Plus) | 0.07 |

### Spring Formula 4

| | Formula % wt. |
|---|---|
| Maltodextrin | 33.10 |
| Cornstarch | 26.80 |
| Vegetable Shortening | 20.00 |
| Palm Oil (Stable Flake ® P) | 12.00 |
| Peanut Flour | 4.00 |
| Lecithin Liquid | 1.80 |
| Calcium (Unical ™ S) | 1.80 |
| Powdered Salt | 0.43 |
| Antioxidant (Naturox ™ Plus) | 0.07 |

Turning to embodiments of energy chips for consumption by birds during winter months, various formulations may be provided. Each formulation generally may comprise at least the following components: cornstarch, vegetable shortening, palm oil (e.g. Stable Flake® P), lecithin, and antioxidant (e.g. Naturox™ Plus). Cornstarch generally may comprise approximately 20-30% by weight of a winter energy chip formulation. Vegetable shortening generally may comprise approximately 15-25% by weight of the resultant composition, with palm oil (Stable Flake® P) comprising approximately 10-15% by weight, lecithin comprising approximately 1-2% by weight, and antioxidant (Naturox™ Plus) comprising approximately 0 to 1% by weight of the resultant composition.

Several embodiments of the winter energy chip formulation generally may also include maltodextrin in an amount ranging from approximately 35-45% by weight of the resultant composition (e.g. Winter Formulas 1-7). In embodiments where maltodextrin is not present, corn sugar may be utilized, also generally comprising approximately 35-45% by weight of the resultant composition (e.g. Winter Formula 8)

In some embodiments of the winter energy chip formulation, peanut flour may be incorporated into the formulation, and peanut flour may generally comprise approximately 3-4% by weight of the resultant composition (e.g. Winter Formulas 1-7). In some embodiments that do not include peanut flour, corn sugar along with paraffin may be incorporated into the formulation (e.g. Winter Formula 8). However, it should be appreciated that paraffin may be incorporated into formulations that do include peanut flour without departing from the present disclosure (e.g. Winter Formulas 4-7). Further, paraffin may be a component in embodiments of a winter energy chip formulation when peanut flour and/or corn sugar have been incorporated as part of the formulation (e.g. Winter Formulas 4-8). Paraffin may be incorporated in a percentage ranging from approximately 0 to 1.5% by weight of the resultant composition. The percentage of paraffin employed may increase, for example, if less cornstarch is present in the formulation, or if less, or even no, peanut flour is incorporated into the formulation. A summary of several embodiments of winter energy chip formulations is provided below.

### Winter Formula 1

| | Formula % wt. |
|---|---|
| Maltodextrin | 35.00 |
| Cornstarch | 25.92 |
| Vegetable Shortening | 22.00 |
| Palm Oil (Stable Flake ® P) | 11.50 |
| Peanut Flour | 3.50 |
| Lecithin Liquid | 2.00 |
| Antioxidant (Naturox ™ Plus) | 0.08 |

### Winter Formula 2

| | Formula % wt. |
|---|---|
| Maltodextrin | 35.00 |
| Cornstarch | 25.92 |
| Vegetable Shortening | 22.00 |
| Palm Oil (Stable Flake ® P) | 12.50 |
| Peanut Flour | 3.50 |
| Lecithin Liquid | 1.00 |
| Antioxidant (Naturox ™ Plus) | 0.08 |

### Winter Formula 3

| | Formula % wt. |
|---|---|
| Maltodextrin | 35.00 |
| Cornstarch | 25.92 |
| Vegetable Shortening | 22.25 |
| Palm Oil (Stable Flake ® P) | 12.00 |
| Peanut Flour | 3.50 |
| Lecithin Liquid | 1.25 |
| Antioxidant (Naturox ™ Plus) | 0.08 |

### Winter Formula 4

| | Formula % wt. |
|---|---|
| Maltodextrin | 35.00 |
| Cornstarch | 25.42 |
| Vegetable Shortening | 22.25 |
| Palm Oil (Stable Flake ® P) | 12.00 |
| Peanut Flour | 3.50 |
| Lecithin Liquid | 1.25 |
| Antioxidant (Naturox ™ Plus) | 0.08 |
| Paraffin | 0.50 |

### Winter Formula 5

| | Formula % wt. |
|---|---|
| Maltodextrin | 35.50 |
| Cornstarch | 25.00 |
| Vegetable Shortening | 21.75 |
| Palm Oil (Stable Flake ® P) | 12.00 |
| Peanut Flour | 3.50 |
| Lecithin Liquid | 1.25 |
| Antioxidant (Naturox ™ Plus) | 0.08 |
| Paraffin | 0.92 |

### Winter Formula 6

| | Formula % wt. |
|---|---|
| Maltodextrin | 41.63 |
| Cornstarch | 22.62 |
| Vegetable Shortening | 19.23 |
| Palm Oil (Stable Flake ® P) | 10.86 |
| Peanut Flour | 3.17 |
| Lecithin Liquid | 1.13 |
| Antioxidant (Naturox ™ Plus) | 0.07 |
| Paraffin | 1.29 |

### Winter Formula 7

| | Formula % wt. |
|---|---|
| Maltodextrin | 42.12 |
| Cornstarch | 20.50 |
| Vegetable Shortening | 20.00 |
| Palm Oil (Stable Flake ® P) | 12.00 |
| Peanut Flour | 3.00 |
| Lecithin Liquid | 1.00 |
| Antioxidant (Naturox ™ Plus) | 0.08 |
| Paraffin | 1.30 |

### Winter Formula 8

| | Formula % wt. |
|---|---|
| Corn Sugar | 42.00 |
| Cornstarch | 23.62 |
| Vegetable Shortening | 20.00 |
| Palm Oil (Stable Flake ® P) | 12.00 |
| Lecithin Liquid | 1.00 |
| Antioxidant (Naturox ™ Plus) | 0.08 |
| Paraffin | 1.30 |

Several different summer fall energy chip formulations also may be provided according to embodiments of the present disclosure. Each of these embodiments generally may include at least the following components: vegetable shortening, palm oil (e.g. Stable Flake® P), cornstarch, antioxidant (e.g. Naturox™ Plus), Vitamin E, and isolated soy protein (e.g. ProF from Fuji). Vegetable shortening may comprise approximately 15-25% by weight of the resultant composition. Palm oil (Stable Flake® P) may comprise approximately 10-20% by weight of the resultant composition, with cornstarch comprising approximately 20-30% by weight, antioxidant (Naturox™ Plus) comprising approximately 0 to 0.10% by weight, Vitamin E comprising approximately 0.3 to 0.7% by weight, and isolated soy protein comprising approximately 0.3 to 0.7% by weight of the resultant composition.

In some embodiments of the present disclosure related to summer fall energy chip formulations, maltodextrin also may be incorporated into such formulations (e.g. Summer Fall Formulas 2-8). In such formulations, maltodextrin may comprise anywhere from approximately 15-45% by weight of the resultant composition. In formulations of summer fall energy chips where maltodextrin may comprise more than about 30% by weight of the resultant composition, generally less cornstarch and/or corn sugar may be present in such formulations.

In certain embodiments, lecithin liquid may be incorporated into the summer fall energy chip formulation in a range of approximately 0.25 to 1% by weight of the resultant composition (e.g. Summer Fall Formulas 1-3 and 6-8). There also may be embodiments of summer fall energy chips where paraffin may be present along with lecithin liquid (e.g. Summer Fall Formulas 1-3, 7 and 8), although lecithin liquid need not be present in order for such formulations to include paraffin. In embodiments including paraffin (either with or without the presence of lecithin), paraffin may comprise approximately 0.5 to 1.5% by weight of the resultant composition (e.g. Summer Fall Formulas 1-3, 7 and 8).

Corn sugar also may be incorporated into summer fall energy chip formulations according to embodiments of the present disclosure (e.g. Summer Fall Formulas 1-6). In such embodiments, corn sugar may comprise anywhere from approximately 10-45% by weight of the resultant composition. It should be appreciated that generally a lower percentage of corn sugar may be present in summer fall formulations where maltodextrin is not included as a component of the formulation.

In other embodiments of the summer fall energy chip formulation, peanut flour (e.g. Summer Fall Formulas 7-8) and/or distilled monoglyceride (DMG) (e.g. Summer Formulas 6-8) may be incorporated into the formulation. It should be appreciated that at least DMG may be included as a component of formulations that include corn sugar (e.g. Summer Fall Formula 6) without departing from the present disclosure while several embodiments that include DMG and peanut flour do not include corn sugar (e.g. Summer Fall Formulas 7-8). DMG may comprise approximately 0.2-0.5% by weight of the resultant composition, and peanut flour generally may comprise approximately 1-2% by weight of the resultant composition. A summary of several embodiments of the summer fall energy chip formulation is provided below.

### Summer Fall Formula 1

| | Formula % wt. |
|---|---|
| Corn Sugar | 42.00 |
| Cornstarch | 22.62 |
| Vegetable Shortening | 20.00 |
| Palm Oil (Stable Flake ® P) | 12.00 |
| Lecithin Liquid | 1.00 |
| Antioxidant (Naturox ™ Plus) | 0.08 |
| Paraffin | 1.30 |
| Vitamin E | 0.50 |
| Isolated Soy Protein | 0.50 |

### Summer Fall Formula 2

| | Formula % wt. |
|---|---|
| Corn Sugar | 23.42 |
| Maltodextrin | 18.00 |
| Cornstarch | 22.00 |
| Vegetable Shortening | 20.00 |
| Palm Oil (Stable Flake ® P) | 13.00 |
| Lecithin Liquid | 1.00 |
| Antioxidant (Naturox ™ Plus) | 0.08 |
| Paraffin | 1.50 |
| Vitamin E | 0.50 |
| Isolated Soy Protein | 0.50 |

### Summer Fall Formula 3

| | Formula % wt. |
|---|---|
| Maltodextrin | 35.00 |
| Corn Sugar | 11.42 |
| Cornstarch | 20.00 |
| Vegetable Shortening | 18.00 |
| Palm Oil (Stable Flake ® P) | 12.00 |
| Lecithin Liquid | 1.00 |
| Antioxidant (Naturox ™ Plus) | 0.08 |
| Paraffin | 1.50 |
| Vitamin E | 0.50 |
| Isolated Soy Protein | 0.50 |

### Summer Fall Formula 4

| | Formula % wt. |
|---|---|
| Maltodextrin | 16.57 |
| Corn Sugar | 21.57 |
| Cornstarch | 20.26 |
| Vegetable Shortening | 23.02 |
| Palm Oil (Stable Flake ® P) | 17.59 |
| Antioxidant (Naturox ™ Plus) | 0.07 |
| Vitamin E | 0.46 |
| Isolated Soy Protein | 0.46 |

### Summer Fall Formula 5

| | Formula % wt. |
|---|---|
| Maltodextrin | 16.60 |
| Corn Sugar | 21.50 |
| Cornstarch | 20.23 |
| Vegetable Shortening | 23.02 |
| Palm Oil (Stable Flake ® P) | 17.60 |
| Antioxidant (Naturox ™ Plus) | 0.07 |
| Vitamin E | 0.50 |
| Isolated Soy Protein | 0.50 |

### Summer Fall Formula 6

| | Formula % wt. |
|---|---|
| Maltodextrin | 16.60 |
| Corn Sugar | 21.00 |
| Cornstarch | 20.23 |
| Vegetable Shortening | 23.00 |
| Palm Oil (Stable Flake ® P) | 17.60 |
| Lecithin Liquid | 0.25 |
| Antioxidant (Naturox ™ Plus) | 0.07 |
| Vitamin E | 0.50 |
| Isolated Soy Protein | 0.50 |
| Distilled Monoglyceride (DMG) | 0.25 |

### Summer Fall Formula 7

| | Formula % wt. |
|---|---|
| Maltodextrin | 42.13 |
| Cornstarch | 20.50 |
| Vegetable Shortening | 20.00 |
| Palm Oil (Stable Flake ® P) | 12.00 |
| Peanut Flour | 1.75 |
| Lecithin Liquid | 1.00 |
| Antioxidant (Naturox ™ Plus) | 0.07 |
| Paraffin | 1.30 |
| Vitamin E | 0.50 |
| Isolated Soy Protein | 0.50 |
| Distilled Monoglyceride (DMG) | 0.25 |

### Summer Fall Formula 8

| | Formula % wt. |
|---|---|
| Maltodextrin | 42.13 |
| Cornstarch | 20.50 |
| Vegetable Shortening | 20.00 |
| Palm Oil (Stable Flake ® P) | 12.72 |
| Peanut Flour | 1.75 |
| Lecithin Liquid | 1.00 |
| Antioxidant (Naturox ™ Plus) | 0.07 |
| Paraffin | 0.58 |
| Vitamin E | 0.50 |
| Isolated Soy Protein | 0.50 |
| Distilled Monoglyceride (DMG) | 0.25 |

Energy chip formulations, including the embodiments described above, may be manufactured according to embodiments of the present disclosure as follows. A mixing kettle or other similar vessel/container may be heated to approximately 150 degrees Fahrenheit. Once the mixing kettle has been heated, the following ingredients (should they be incorporated into the desired energy chip formulation) may then be added to the mixing kettle in the following order: vegetable shortening, palm oil flakes, paraffin, DMG, and Naturox Plus. These components should be mixed until completely blended and melted, thereby forming a first blend.

The following components (should they be incorporated into the desired energy chip formulation) may then be added in the following order to the first blend: vitamin E, soy protein, and peanut flour. These components may be mixed together, thereby forming a second blend.

The following components (should they be incorporated into the desired energy chip formulation) may then be added in the following order to the second blend: half of the cornstarch, maltodextrin, lecithin, and the other half of the cornstarch. These components may then be mixed with the second blend until completely blended, thereby forming a third blend.

A cooling apparatus should then be cooled to a temperature of approximately 40 degrees Fahrenheit, and the cooler belt should then be activated to receive the third blend. A valve on the mixing kettle may then be opened in order to fill the depositor. The depositor may be set to produce the size of energy chips that is desired. For example, the energy chips may have an oblong shape, having a length of 0.375 inch to 0.75 inch, a width of 0.375 inch to 0.625 inch and a thickness of 0.25 inch. Once the energy chips have been produced, they may be placed into a tote sack for use as a component in birdseed formulations or for use on their own. As an example, energy chips formed according to embodiments of the present disclosure may be blended into a bag of other seeds to be fed to birds.

As used herein, maltodextrin may be understood as a polysaccharide which consists of D-glucose units connected in various length chains, and may have a dextrose equivalent classification of 3 to 20.

As used herein, corn sugar may also be understood to be sugar extracted from corn.

As used herein, cornstarch may be understood as the starch of the corn (maize) grain obtained from the endosperm of the corn kernel.

As used herein, vegetable shortening may be understood as pure vegetable fat that is a solid at room temperature (21° C./70° F.), also be referred to as hydrogenated vegetable oil, ordinarily used to prevent cross-linkage between gluten molecules in pastry.

As used herein, peanut flour may be understood as flour made from crushed, defatted (partially or fully) peanuts.

As used herein, lecithin may be understood as a mixture of various phospholipids in oil.

As used herein, paraffin may be understood as an oil or wax mixture of alkanes indicated by the general formula CₙH₂ₙ₊₂ and which may particularly fall in the 20≦n≦40 range.

As used herein, isolated soy protein may be understood as protein which is isolated from soybean.

As used herein a distilled monoglyceride may be understood as a glyceride consisting of one fatty acid chain.

Although the present disclosure has been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A food comprising:
a bird food composition, the composition comprising cornstarch, vegetable shortening, hydrogenated palm oil, and at least one of maltodextrin and corn sugar; and
wherein a total combined weight of the cornstarch, vegetable shortening, hydrogenated palm oil, and at least one of maltodextrin and corn sugar is at least 60% by weight of the composition.

2. The food of claim 1 wherein:
the total combined weight of the cornstarch, vegetable shortening, hydrogenated palm oil, and at least one of maltodextrin and corn sugar is at least 70% by weight of the composition.

3. The food of claim 1 wherein:
the total combined weight of the cornstarch, vegetable shortening, hydrogenated palm oil, and at least one of maltodextrin and corn sugar is at least 80% by weight of the composition.

4. The food of claim 1 wherein:
the total combined weight of the cornstarch, vegetable shortening, hydrogenated palm oil, and at least one of maltodextrin and corn sugar is at least 90% by weight of the composition.

5. The food of claim 1 further comprising:
peanut flour.

6. The food of claim 1 further comprising:
lecithin.

7. The food of claim 1 further comprising:
calcium carbonate.

8. The food of claim 1 further comprising:
salt.

9. The food of claim 1 further comprising:
an least one antioxidant.

10. The food of claim 1 further comprising:
paraffin.

11. The food of claim 1 further comprising:
at least one vitamin.

12. The food of claim 1 further comprising:
soy protein.

13. The food of claim 1 further comprising:
monogylceride.

14. The food of claim 1 wherein:
the composition does not contain animal fat.

15. The food of claim 1 wherein:
the composition is formed into a shape of at least one of a chip and a pellet.

16. A method of preparing food wherein:
identifying a bird food composition, wherein the composition comprises a plurality of ingredients comprising cornstarch, vegetable shortening, hydrogenated palm oil, and at least one of maltodextrin and corn sugar, wherein a total combined weight of the cornstarch, vegetable shortening, hydrogenated palm oil, and at least one of maltodextrin and corn sugar is at least 60% by weight of the composition; and
producing the bird food composition from the ingredients.

17. The method of claim 16 wherein:
forming the bird food composition into a shape of at least one of a chip and a pellet.

18. The method of claim 16 wherein:
the total combined weight of the cornstarch, vegetable shortening, hydrogenated palm oil, and at least one of maltodextrin and corn sugar is at least 70% by weight of the composition.

19. The method of claim 16 wherein:
the total combined weight of the cornstarch, vegetable shortening, hydrogenated palm oil, and at least one of maltodextrin and corn sugar is at least 80% by weight of the composition.

20. The method of claim 16 wherein:
the total combined weight of the cornstarch, vegetable shortening, hydrogenated palm oil, and at least one of maltodextrin and corn sugar is at least 90% by weight of the composition.
